(19) United States
(12) Patent Application Publication
(10) Pub. No.: US 2016/0125916 A1
(43) Pub. Date: May 5, 2016

(54) Collaborative Movie Creation

(71) Applicant: ShotClip Limited, Newry (IE)

(72) Inventors: Conor McNally, Dublin (IE); Alan Quigley, Dublin (IE)

(21) Appl. No.: 14/929,862

(22) Filed: Nov. 2, 2015

Related U.S. Application Data
(60) Provisional application No. 62/073,513, filed on Oct. 31, 2014.

(51) Int. Cl. G11B 27/034; G11B 27/34; G11B 31/00; G11B 27/10

(52) U.S. Cl. CPC G11B 27/034; G11B 27/105; G11B 27/34; G11B 31/00

(57) ABSTRACT

Methods, systems, and apparatus, including computer programs encoded on a computer storage medium, are described that enable crowd-sourced collaborative movie-making. An aggregate set of movies contributed by one or more users may be analyzed to determine statistical information regarding selection of different media clips by the crowd of contributors, as well as to determine metadata information of the media clips selected by the crowd of contributors. Based on the statistical usage information and the metadata information of the aggregate set of movies contributed by the crowd, different types of crowd-view movies may be generated that represent different views and themes of the collaborative movie-making effort of the crowd. Different crowd-view movies may therefore be generated from the same set of contributed movies based on the specific preferences of a viewer requesting to view a crowd-view movie.

### CROSS-REFERENCE TO RELATED APPLICATIONS

This application claims the benefit of an earlier filing date and right of priority to U.S. Provisional Application Ser. No. 62/073,513, filed on Oct. 31, 2014, the contents of which are hereby incorporated by reference in their entirety.

### TECHNICAL FIELD

This specification generally describes systems and processes for crowd-based collaborative movie making.

### BACKGROUND

Video editing tools allow users to edit, create, and share videos. Some video editing tools allow users to create movies by combining different types of media files, e.g., video files, image files, and audio files, in a sequence, or timeline. Video editing tools are typically available either online as web-based applications, offline as downloadable software, or on mobile devices as mobile applications.

### SUMMARY

In some aspects, the subject matter described in this specification may be embodied in methods that may include the actions of determining, by a processor, a timeline of shots for a movie and, for each user in a group of users, receiving, from a device of the user and for each shot of the timeline, a selection of one or more media clips associated with the shot, and storing, in the computer memory, the selected one or more media clips associated with the shot in a sequence of media clips selected by the user for the timeline of shots, the sequence of media clips defining a version of the movie created by the user, determining, by the processor, selection information related to the selection of media clips by the group of users in creating the versions of the movie, and storing, in the computer memory, the selection information.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

In some implementations, the actions may, for a particular shot in the timeline, further include accessing, by the processor, a set of candidate media clips that is stored in the computer memory, and associating the set of candidate media clips with the particular shot in the timeline. The selected one or more media clips may be selected from among the set of candidate media clips associated with the particular shot in the timeline.

In these implementations, the actions may, for instance, further include downloading, from a predetermined database, at least one candidate media clip of the set of candidate media clips. In some examples, actions of these implementations may further include receiving, from a user, at least one candidate media clip of the set of candidate media clips. In one aspect, associating a set of candidate media clips with each shot of the timeline may, for example, include determining, for each shot of the timeline, an ordering for the set of candidate media clips associated with the shot based on analyzing metadata associated with the set of candidate media clips or based on the selection information related to the selection of media clips by the group of users in creating the versions of the movie.

In some examples, actions of these implementations may further include determining metadata associated with the set of candidate media clips and storing the metadata. In such examples, the information regarding a user may be related to at least one of a location of the user, a time at which the user uploaded the candidate media clip, one or more social network connections of the user, or demographic information associated with the user.

In some implementations, the actions may, for a particular shot in the timeline, further include transmitting, to a device of at least one user in the group of users, an indication to record a media clip for the particular shot in the timeline, receiving, from the device of the at least one user, a recorded media clip for the particular shot in the timeline, and setting, by the processor and for the at least one user, the recorded media clip as the selection of one or more media clips associated with the particular shot in the timeline.

In some examples, determining the timeline of shots for the movie may include receiving an ordered sequence of shots. The selected one or more media clips for the shot may, in some examples, include at least one of a video file, an image file, or an audio file.

In some implementations, each shot in the timeline of shots for the movie may include a description of a scene or portion of a story associated with the movie. In these implementations, the metadata may include information regarding a characteristic of audio, video, image, or text that appears in a candidate media clip. The metadata may, in some examples, include information regarding a source of a candidate media clip.

In some aspects, the subject matter described in this specification may be embodied in methods that may include the actions of receiving, from a viewer, a request to view a version of a movie according to one or more preferences specified by the viewer, accessing one or more stored sequences of media clips created by a group of users, each sequence of media clips defining a version of the movie created by a user in the group of users, generating the requested version of the movie according to the one or more preferences specified by the viewer based on selecting, for each shot in a timeline of shots for the movie, one or more media clips that are used for the shot in at least one of the one or more stored sequences of media clips created by a group of users, and displaying, for the viewer, the requested version of the movie.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

In some implementations, the one or more preferences specified by the viewer may include a preference to view the requested version of the movie based on a frequency or timing with which media clips were selected by the group of users in creating the versions of the movie.

In some examples, the one or more preferences specified by the viewer may include a preference to view the requested version of the movie based on a characteristic of audio, video, or text that appears in one or more media clips in the versions of the movie created by the group of users.

In some implementations, selecting, for each shot in a timeline of shots for the movie, one or more media clips that are used for the shot in at least one of the one or more stored sequences of media clips created by a group of users may include selecting the one or more media clips based on at least one of selection information related to the selection of the one or more media clips by the group of users in creating the versions of the movie, or metadata associated with the one or more media clips.

In some examples, actions may further include receiving feedback from the viewer regarding the displayed requested version of the movie, and updating, based on the received feedback from the viewer regarding the displayed requested version of the movie, an algorithm that is used to generate the requested version of the movie according to one or more preferences specified by the viewer.

In some implementations, actions may further include receiving, from a second viewer, a request to view a second version of a movie according to one or more preferences specified by the second viewer, accessing the one or more stored sequences of media clips created by the group of users, generating the requested second version of the movie according to the one or more preferences specified by the second viewer based on selecting, for each shot in the timeline of shots for the movie, one or more media clips that are used for the shot in at least one of the one or more stored sequences of media clips created by the group of users, and displaying, for the second viewer, the requested second version of the movie.

In some examples, the one or more preferences specified by the viewer may include a preference to view the requested version of the movie based on versions of the movie created by users in the group of users who have a particular demographic profile. In these examples, the selection information for the one or more media clips may, in some implementations, include information regarding a frequency or timing with which the one or more media clips were selected by the group of users in creating the versions of the movie. In these examples, the selection information for the one or more media clips may, in some implementations, include a frequency or timing with which the one or more media clips were selected with one or more particular media clips in the same sequence of media clips by the group of users in creating the versions of the movie. The demographic information associated with users who selected the one or more media clips to appear in versions of the movie created by the users may, in these implementations, include information regarding a relationship between the users who selected the one or more media clips and the viewer.

In these examples, the selection information for the one or more media clips may, in some implementations, include a rating that has been assigned to the one or more media clips by the group of users in creating the versions of the movie. In these examples, the selection information for the one or more media clips may, in some implementations, include demographic information associated with users who selected the one or more media clips to appear in versions of the movie created by the users.

In these examples, the metadata associated with the one or more media clips may, in some implementations, include information regarding a characteristic of audio, video, or text that appears in the one or more media clips, and where the characteristic of video is related to background information or foreground information of the video. In these examples, the metadata associated with the one or more media clips may, in some implementations, include information regarding a source of the one or more media clips. In these examples, the metadata associated with the one or more media clips may, in some implementations, include information regarding at least one of a geographic location or a time at which the one or more media clips were uploaded.

The details of one or more implementations are set forth in the accompanying drawings and the description below. Other potential features and advantages will become apparent from the description, the drawings, and the claims.

Other implementations of these aspects include corresponding systems, apparatus and computer programs, configured to perform the actions of the methods, encoded on computer storage devices.

### BRIEF DESCRIPTION OF DRAWINGS

FIG. 1 is a block diagram illustrating an example of a system that can implement crowd-based collaborative movie-making;

FIG. 2 is a diagram illustrating an example of a process of crowd-based collaborative movie-making;

FIG. 3 is a block diagram of an example of an architecture to enable crowd-based collaborative movie making;

FIG. 4 is a block diagram illustrating an example of a user-specific database that may be used in a crowd-based collaborative movie making system;

FIG. 5 is a flow chart illustrating an example of crowd-based collaborative movie making; and

FIGS. 6-25 are diagrams of examples of graphical user interfaces (GUIs) that enable crowd-based collaborative movie making.

In the following text, a detailed description of examples will be given with reference to the drawings. It should be understood that various modifications to the examples may be made. In particular, elements of one example may be combined and used in other examples to form new examples. Like reference symbols in the various drawings indicate like elements.

### DETAILED DESCRIPTION

Techniques described herein enable crowd-sourced collaborative movie-making by enabling multiple users, referred to by this specification as “contributors,” to create different versions of a movie, and by processing the different versions of the movie created by the contributors to generate a synthesized movie, referred to by this specification as “a crowd-view movie,” that represents the collaborative movie-making effort of the crowd of contributors. The system is able to scale to a large number of movie-making collaborators by utilizing algorithms that analyze the aggregate set of movies contributed by the crowd to determine various statistical properties of media content that have been selected by the contributors. The system generates a representative crowd-view movie based on the statistical properties gleaned from the crowd-sourced content, as well as based on metadata associated with the crowd-sourced content.

In some implementations, a video editing application provides contributors with a library of media clips, e.g., video clips, image files, audio clips, etc., that may be used to generate crowd-sourced movies. A movie-making project may be initiated by a particular user, referred to by this specification as “a director,” who defines a timeline for the movie that establishes a sequence of shots according to which media clips may be pieced together to form the movie. Contributors may then select media clips from the library, or may upload their own media clips, to create media content for each shot in the director's timeline, and thus define their own versions of the movie. The system may then analyze the different versions of the movie that have been contributed, and generate a single crowd-view movie that represents the collaborative movie-making effort of the crowd of contributors.

In some implementations, the system may generate the representative crowd-view movie using any one of a number of possible criteria specified by a viewer. As such, the system is not necessarily limited to generating a single crowd-view movie from the set of contributed movies, but may adaptively generate different types of crowd-view movies based on the particular preferences of different viewers who wish to view different themes or styles of movies based on the set of crowd-contributed movies.

As an example, based on a set of crowd-contributed movies, a particular viewer may wish to view a crowd-view movie that represents the most popular media content selected by the contributors, and the system may accordingly generate a crowd-view movie by selecting, for each shot in the movie's timeline, the media clip that was most frequently used for that shot in different versions of the movie contributed by the crowd. As another example, based on the same set of crowd-contributed movies, a different viewer may wish to view a crowd-view movie that represents the most popular media content selected by a particular demographic profile of the crowd, e.g., contributors of a particular gender, contributors in a particular geographic location, contributors of a particular age, etc., and the system may accordingly generate a crowd-view movie by selecting, for each shot in the movie's timeline, the media clip that was most frequently used for that shot in different versions of the movie contributed by members of the crowd satisfying the viewer's preferred demographic profile.

As such, the system not only enables a potentially large number of users to contribute different versions of a movie to a movie-making process, but also processes the user-contributed movies in different ways to enable viewers to view personalized types of movies that are generated from the same user-contributed content, based on the viewer's specific interests. As more contributors create different versions of the movie, and also as more contributors upload new media clips to the library of media clips available to other collaborating contributors, the system may be able to generate more variegated types of crowd-view movies by sequencing different combinations and permutations of media clips together in the timeline of shots.

The system thus enables crowd-sourced moviemaking by aggregating different versions of a movie created by a crowd of contributors, and analyzing the aggregate set of movies to generate different crowd-view movies that represent different views or themes of the collaborative movie-making effort of the crowd. The system is able to scale to a potentially large number of contributors by utilizing various statistical properties of the media clips selected by the contributors who created the different versions of the movie, as well as by utilizing metadata associated with the different media clips, and thus efficiently search for and select media clips that satisfy the desired properties of a viewer, e.g., most popular clips, clips uploaded by particular types of users, clips uploaded at certain times, etc.

The system enables collaborative moviemaking on a larger scale than would otherwise be possible by merely allowing a group of users to manually edit a commonly accessible timeline using a shared library of media clips. In such scenarios, although there can potentially be many users who upload media clips to the shared library, only a few users can practically edit the shared timeline and determine the ultimate storyline, due to practical constraints in manual editing. Instead, implementations according to the present disclosure enable larger-scale collaborative movie-making by utilizing statistical properties and/or metadata of the potentially large number of user-contributed movies, and automatically generating a resulting crowd-view movie that represents a convergence of the crowd-contributed movies.

In some implementations, a director may define a timeline for a movie to be created, the timeline including a number of shots to be placed in sequence. For each shot in the sequence of the movie's timeline, there may be stored and maintained a collection of media clips that are candidates for that particular shot in the sequence. For example, if a movie timeline consists of a sequence of 10 shots, then the system may store and maintain 10 different collections of media clips, each collection including media clips that are candidates for one of the 10 shots in the movie's timeline. Each collection may include media clips that have been contributed by individual users and/or media clips that have been generated by the system. For example, the collection of media clips may be initially populated by the director who defined the timeline, and/or may be dynamically populated as contributors upload media clips to create their versions of the movie. In some implementations, the collection of media clips may be automatically populated by the system, for example based on a preexisting database of available media content.

In some implementations, the system may extract various types of metadata from the media clips and store this metadata in a metadata database. The extracted metadata may then subsequently be used by the system to select particular media clips from among the aggregate set of media clips selected/uploaded by contributors. In some implementations, the media clips within each collection in the timeline may be ordered based on a suitable criterion, e.g., by popularity, location, date, relationship to the person uploading the clip, etc.

Based on the initial timeline defined by the director, the contributors may generate different versions of the movie by selecting media clips from among the collection of available media clips for each shot in the timeline, or by uploading their own media clips, which may then be added to the collection for the corresponding shot. The sequence of media clips selected or uploaded by a particular contributor defines a particular version of the movie created by that contributor. The system thus stores different versions of the movie that have been created by different contributors, and analyzes the aggregate set of media clips that have been selected by the contributors in creating the different versions.

In some implementations, the system may transmit a notification to contributors to record a media clip for a particular shot of the timeline. The system may send, for example, a push notification to one or more contributors. After a contributor receives the notification, the contributor may be provided with a graphical user interface to record a media clip for the particular shot of the timeline. The recorded media clip may then be transmitted back to the system, which may include the recorded media clip among the set of candidate media clips as the media clip selection by the contributor for the particular shot.

Based on the analysis of the media clips selected by contributors, various types of statistical information regarding the selection decisions by contributors may be stored in a selection decisions database. Such information may include, for example, media clips that are frequently used by contributors, particular groupings of media clips that are frequently used together in a movie (or conversely, clips that are rarely used together in a movie), etc. The system may therefore use statistical information from the selection decisions database, in conjunction with metadata stored in the metadata database, to select a particular sequence of media clips that represents a “crowd-view” movie.

The crowd-view movie may be tailored to the preferences of a viewer. For example, a viewer may request to view a particular type of crowd-sourced movie. The system may enable the viewer to select one or more criteria based upon which the crowd-view movie is generated from the aggregate set of movies contributed by the crowd. Each movie clip in the sequence of shots in the representative crowd-view movie may be selected by the system according to the criteria defined by the viewer.

For example, the viewer may wish to view a crowd-view movie representing a movie that is popular with a particular segment of the crowd of contributors, such as based on contributors in a particular country, contributors of a particular gender, contributors who are friends of the viewer, contributors who are of a particular age range, etc. As another example, the viewer may wish to view a crowd-view movie based on particular characteristics of media clips that make up the movie, such as background/foreground characteristics of the media clips, particular words spoken (or not spoken) in the media clips, particular images displayed (or not displayed) in the media clips, etc. Based on the one or more criteria selected by the viewer, the system may analyze the aggregate set of movies created by the crowd of contributors to generate a suitable crowd-view movie for the viewer.

As such, the system enables different viewers to enjoy a rich set of different crowd-view movies that represent different views or themes based on the same set of movies that have been contributed by a crowd of collaborating movie-makers. The rich set of possible crowd-view movies generated by the system may be further enhanced as the number of collaborating movie-makers grows, enabling the system to reap the benefits of, rather than be stagnated by, scaling to a large number of collaborating movie-makers.

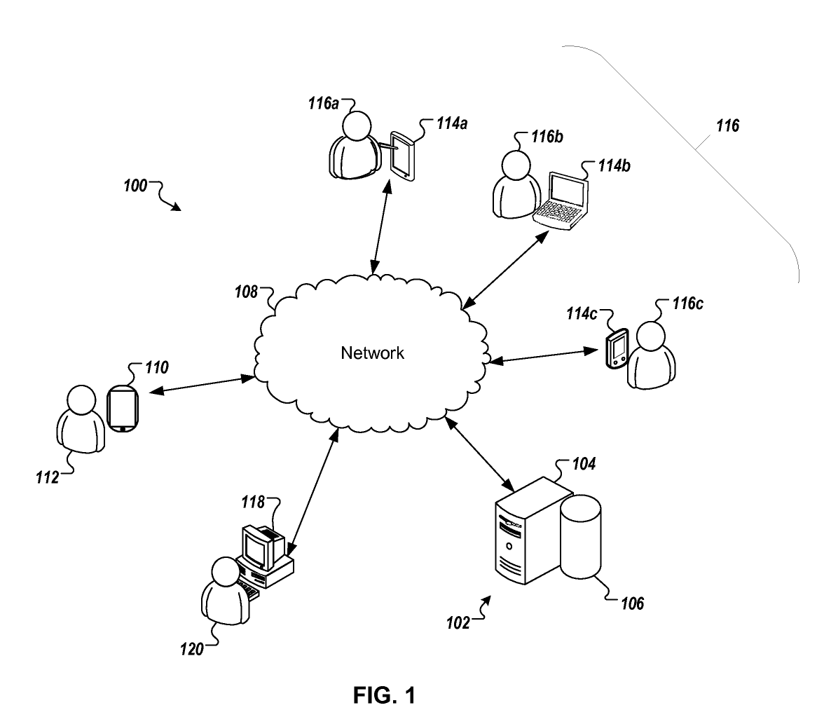

FIG. 1 depicts an example system 100 that can execute implementations of the present disclosure. The example system 100 includes a computing system 102 that includes one or more computing devices 104 and one or more computer-readable storage devices 106. The computing system 102 is able to communicate with one or more other devices through a communication network 108, and enables collaborative movie-making among multiple users who may be geographically separated.

In the example of FIG. 1, the computing system 102 is communicative with device 110 operated by a user 112, who may be a viewer requesting to view a crowd-view movie. The computing system 102 may generate the requested crowd-view movie by analyzing different versions of the movie that have been contributed by a crowd of users, for example via devices 114a, 114b, 114c operated by contributors 116a, 116b, 116c, respectively. The crowd of contributors 116 may create different versions of the movie based on a timeline created by a particular user, for example via device 118 operated by director 120. Although shown as separate users in FIG. 1, in some implementations, two or more of the viewer 112, the contributors 116a-116c, and the director 120 may represent the same user, so that, for example, the director 120 may also be the viewer 112, and/or one of the contributors 116 may also be the director 120, etc.

In some implementations, the computing devices 110, 114a, 114b, 114c, and 118 are computing devices such as laptop or desktop computers, smartphones, personal digital assistants, wearable computers, portable media players, tablet computers, or other appropriate computing devices that can be used to communicate with an electronic communication network. In some implementations, the computing devices 110, 114a, 114b, 114c, and 118 perform client-side operations, as discussed in further detail herein. In some implementations, the computing system 102 includes one or more computing devices such as a computer server. In some implementations, the computing system 102 represents more than one computing device working together to perform the server-side operations, as discussed in further detail herein.

In some implementations, the network 108 is a public communication network, e.g., the Internet, cellular data network, dialup modems over a telephone network, or a private communications network, e.g., private LAN, leased lines. The network 108 may include one or more networks. The network(s) may provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, General Packet Radio System (GPRS), or one or more television or cable networks, among others. For example, the communication may occur through a radio-frequency transceiver. In addition, short-range communication may occur, such as using a BLUETOOTH, Wi-Fi, or other such transceiver.

In some implementations, the example system 100 may be used to generate one or more crowd-sourced movies. For example, the computing system 102 may host, or make available for download, a crowd-sourced movie-making application that is accessible by different users. In some implementations, for example, the viewer 112 may access a movie-viewing interface provided on the computing device 110, the contributors 116a-116c may access a movie-creation interface provided on the computing devices 114a-114c, respectively, and the director 120 may also access a movie-creation interface provided on the computing device 118. In some implementations, the different interfaces may be provided as a web-based application hosted by the computing system 102 and that provides graphical user interfaces within a general purpose web browser executed on the computing devices 110, 114a-114c, and/or 118. In some implementations, the interfaces may be provided as individual downloadable applications (e.g., desktop applications or mobile applications) provided by the computing system 102 and executed on the computing devices 110, 114a-114c, and/or 118, and the applications may be communicative with the computing system 102.

In some implementations, the system 100 enables a director (e.g., director 120) to define a timeline, also referred to by this specification as a storyline, a shot-list or a storyboard, that comprises a sequence of shots that are going to make up the movie. This timeline provides a framework for collaboration by which a crowd of contributors (e.g., the crowd 116 of contributors 116a-116c) can create different versions of the movie by selecting/uploading media clips for each shot of the movie's timeline. The system 100 then enables a viewer (e.g., viewer 112) to view different types of crowd-view movies generated by the computing system 102 based on analyzing the aggregate set of movies created by the contributors 116.

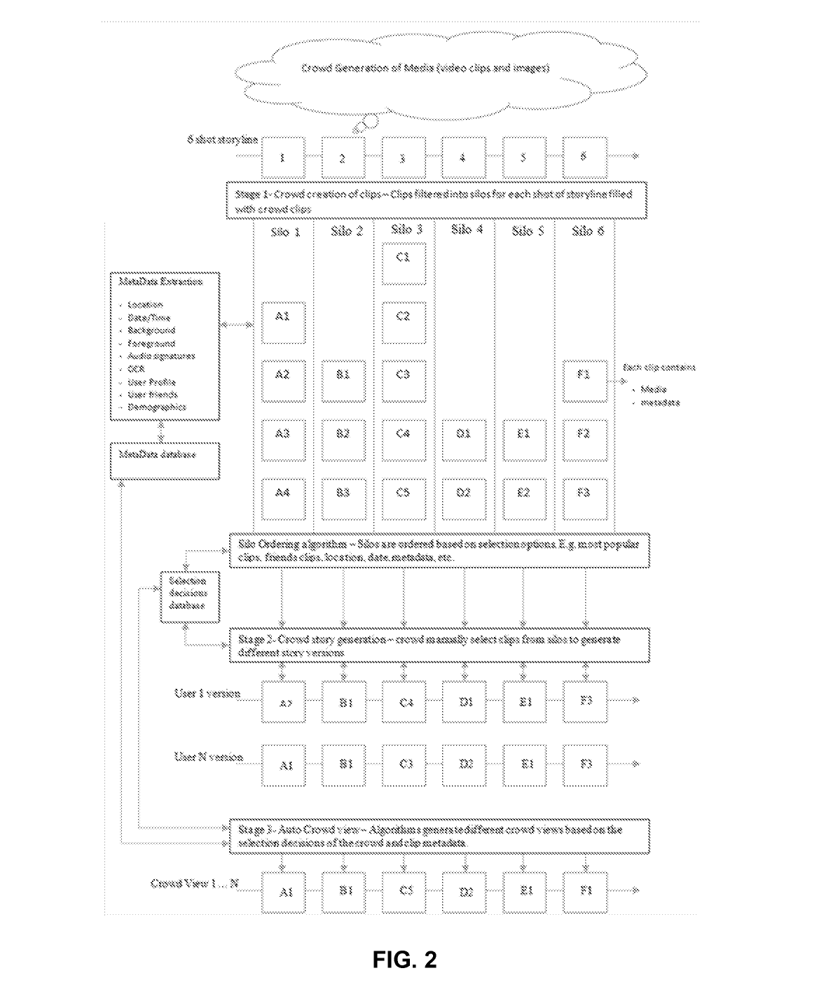

FIG. 2 is diagram illustrating an example of a process of collaborative movie-making. In this example, the movie is a sequence of 6 shots, although in general any suitable number of shots may be used in the movie timeline.

Stage 1: Story Initialization

After the basic timeline of the movie has been defined, e.g., by the director 120 in FIG. 1, media clips are collected and stored for each shot of the timeline. In the example of FIG. 2, each of the 6 shots in the timeline has a corresponding collection (also referred to by this specification as a “silo”) of media clips associated with the shot. For example, the collection (silo) associated with the first shot in the timeline has media clips A1, A2, A3, and A4. Each media clip may have media data (e.g., video data, image data, audio data, etc.) and, in some implementations, may also include metadata that describes the media clip.

The media clips in each collection may be contributed by a crowd of users (e.g., contributors 116 and/or the director 120 in FIG. 1), or may be automatically generated by the system. In some implementations, a collection (silo) of media clips may be automatically filled-in by the system, for example, from a pre-existing database of available media content. Automatic population of media clips in each collection may also be based on metadata including, for example, time, location, type of background/foreground, tagged people/users, audio detection synchronization, etc. In general, the system may use any suitable technique to populate different shots of the timeline with media clips that are considered appropriate for the particular shot.

In some implementations, the system may transmit a notification to the crowd of users to record a media clip for a particular shot of the timeline. This may send, for example, a push notification to the crowd of users. After a user receives the notification, the user may be provided with a user interface to record a media clip for the shot. For example, a graphical user interface may be provided on a device, such as a smartphone, of the user. When the user click on a notification button in the graphical user interface, the user may be provided with an application to record a media clip for the particular shot of the timeline. The recorded media clip may then be transmitted back to the system, which may include the recorded media clip among the set of candidate media clips.

The media clips in each collection are then presented to users (e.g., contributors 116 in FIG. 1) who wish to create their own versions of the movie based on the director-defined timeline. In some implementations, the media clips in each collection (silo) may be presented to a contributor in a particular order, based on a suitable criteria. For example, media clips in each collection may be ordered based on a popularity of the media clip, relationships between the user and other users who uploaded the media clips, geography of users uploading the media clips, time of upload of the media clip, etc. The particular ordering of media clips in each collection (silo) may, in some implementations, be dynamically updated as media clips are selected/uploaded by more users (contributors) who create their own versions of the movie.

Stage 2: Crowd Story Generation

Based on the media clips that are made available in each of the collections (silos) of the director-defined timeline, various contributors in the crowd can start to make their own versions of the movie. Each contributor may create a movie version by uploading his/her own clips to the silos in the crowd project, and/or may use clips that have been previously uploaded by other contributors, by the director, or by the system. As such, a contributor is able to use not only his/her own clips but also clips from other people in the crowd to make his/her own version of the movie.

In the example of FIG. 2, in stage 2, User 1 creates a version of the movie using media clip A2 for the first shot, media clip B1 for the second shot, media clip C4 for the third shot, media clip D1 for the fourth shot, media clip E1 for the fifth shot, and media clip F3 for the sixth shot the timeline. Some of the clips in User 1's version of the movie may have been uploaded by User 1, while other clips in User 1's version of the movie may have been uploaded by other users and/or the system itself. Similarly, in the example of FIG. 2, User 2 may create a different version of the movie using media clips A1, B1, C3, D2, E1, and F3 in sequence. The particular media clip selection decisions by User 1, User 2, and other users may be stored in a selection decisions database.

The selection decisions database may, for example, store various types of information (e.g., statistical information) about the media clips that are used by contributors in creating their versions of the movie. For example, the selection decisions database may store information regarding the most frequently used media clips in each shot of the timeline, and/or particular groupings of media clips (e.g., pairs of media clips, triplets of media clips, or other groupings of media clips) that appear frequently in the versions of the movie created by contributors, and/or other types of information gleaned from the selection decisions of media clips by the crowd of contributors creating different versions of the movie. As a specific example, different media clips may be linked together (e.g., using different weighting factors) according to how frequently those clips appear together in the same version of a movie created by contributors. As such, the system may preferentially use closely-linked media clips together when generating a crowd-view movie (and/or conversely may be biased against using two clips together that rarely appear together in the same versions of the movie).

In some implementations, information from the selection decisions database may be used to re-order the collections (silos) of media clips for each shot of the timeline based on search criteria, e.g. most popular clips, friends' clips, as well as based on metadata including, time, location, type of background/foreground, tagged people/users, audio detection synchronization, etc.

In some implementations, the information stored in the selection decisions database may be presented to contributors as they create their versions of the movie. For example, contributors may view selection decision information indicating which media clips have most frequently been used by other contributors, and/or which groupings of media clips have most frequently been used together in different versions of the movie, and/or information about selection of media clips by particular segments of contributors (e.g., based on geography, demographics, or other characteristics). As such, a contributor may create his/her version of the movie based not only on his/her own preferences for media clips, but also based on preferences of other contributors.

The information in the selection decisions database may also be used, in conjunction with the metadata database for the media clips, in the next stage (Stage 3, described below) to generate a crowd-view movie that represents a particular synthesized view of the different versions of the movie created by the crowd of contributors.

Stage 3: Auto Crowd Views

Crowd views may be automatically generated based on selection decisions of the crowd and/or based on metadata of the media clips used by contributors. For example, a crowd-view movie may be generated based on the most popular media clips for each shot in the context of the storyline that is being created, and/or may be based on particular characteristics (e.g., using metadata) of media clips that have been used by contributors, and/or may be based on media clips selected by contributors with particular characteristics. The crowd-view movie may thus represent a convergence by the crowd of contributors on a number of different themes/views of the movie's timeline, and/or a different convergence based on location or other factors of the contributors themselves.

In the example of FIG. 2, a crowd-view movie is generated using a sequence of media clips A1, B1, C5, D2, E1, and F1. The particular crowd-view movie may be generated using an algorithm that selects media clips for each shot in the timeline based on a suitable criteria defined by the requesting viewer. As a specific example, one possible criteria for selecting media clips for the crowd-view movie is based on popularity of clips used in each shot of the timeline. For example, in some implementations, when a contributor uses another person's media clip in his/her own version of the timeline, that clip may receive a vote. As more and more people join the project and contribute different versions of the movie using other people's (or their own) media clips, the most popular media clips will emerge from the project. This may then enable the most popular media clips for each of the shots in the timeline to be shown as a resulting crowd-view movie. Popularity of media clips may only be one possible factor, however, and different types of crowd-view movies may be generated based on the crowd's decisions, for example, based on geographic location of the contributors, time of selection/upload of the media clips, contributor demographics (age, gender, etc.), audio detection and synchronization of the media clips, etc.

In general, the aggregated selection decisions of the crowd in selecting their favourite clips in the context of the story timeline may be used by the system to generate a crowd-view movie that represents a synthesized view of different versions of the movie that have been created by a potentially large number of contributors. A viewer (e.g., a contributor or non-contributor) may therefore view a crowd-view movie that represents not only his/her own version of the storyline (if he/she contributed one), but also versions that have been created by other users in the crowd. In some implementations, this may add a competitive element to the collaborative moviemaking effort, whereby users may be motivated to contribute better media clips to the timeline in order to attain the most popular position in one or more shots. This competition may also incentivize the contributors to promote their clips to the rest of the crowd community and therefore add a social/viral aspect to the generation of the movie.

As explained above, in addition to the selection decisions of the crowd, the system may also use metadata of the media clips to generate the crowd-view movie. For example, a viewer requesting to see a crowd-view movie may specify that the crowd-view movie have a particular type of soundtrack, or dialogue, or foreground/background, or other characteristics. The system may then search the metadata database for media clips corresponding to the viewer's requested criteria and, in combination with the selection decision statistics gleaned from the different movies created by the crowd of contributors, generate an appropriate crowd-view movie for the requesting viewer.

Although the example in FIG. 2 has been described for a timeline of six shots, the collaborative moviemaking system may apply to any number of shots in a timeline. It may also apply to a timeline organized into a hierarchy of scenes and shots. Also because a collection (silo) of clips is available for each shot position in the timeline, in some implementations, the timeline may use multiple media clips to describe a single shot position (e.g., multiple clips may be used to define a single shot in the timeline) and/or may use a single media clip to describe multiple shots in the timeline (e.g., a single media clip may be used to define multiple shots in the timeline).

Architecture to implement crowd movie making:

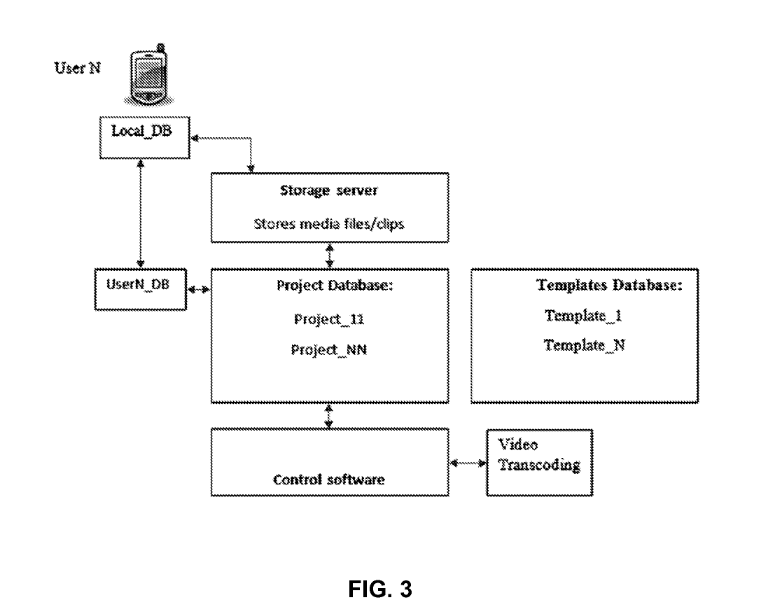

FIG. 3 is a block diagram of an example of an architecture to enable the crowd movie making system. The example of FIG. 3 shows a single user, User N, although in general the system may support any suitable number of users. In this example, multiple users, including User N, may be collaborating on a particular movie-making project, labelled “Project_11.” For example, Project_11 may have a timeline of 10 shots and there may be 1000 people collaborating on it. Project_11 may be one of many projects stored in a projects database (e.g., the “Project Database” in FIG. 3). The Project Database may, for example, be part of the computer-readable storage devices 106 in the computing system 102 of FIG. 1.

The Project Database may store either individual projects or collaborative projects. In the case of collaborative projects, data that is shared between users collaborating on the project may be stored in the Project Database. The Project Database may be communicative with a server (e.g., the “Storage Server” in FIG. 3) that stores media clips uploaded by users and/or by the system, as well as control software (e.g., the “Control Software” in FIG. 3) that performs various control operations related to generating collaborative movies.

For example, changes to a project stored in the Project Database may be detected by the Control Software and indicated to the different users collaborating on the project. In some implementations, the system may use listener modules that monitor for changes in the Project Database that require action, such as users uploading new media clips, a director changing the order of the shots in the template timeline, new users joining the project, users sending emails/invites/notifications to other users, sending a transcode job to the Video Transcoding module, detecting when a user logs in or logs out, or other changes.

In some implementations, the system may also include a database of templates (e.g., the “Template Database” in FIG. 3) that stores one or more templates that may be used to initially create a timeline for a movie. The Templates Database may, in some implementations, the part of the computer-readable storage devices 106 in the computing system 102 of FIG. 1, or may be stored separately and a different location. The Templates Database may contain a list of template documents for users to start projects from. For example, in some patients, each template document stored in a database may contain various types of information, such as:

A starting Project Document.

Name of the Template.

An identifier of a user who created the template.

A Number of Times that the template has been used.

A public/private indicator.

In some implementations, the system may also include a user-specific database (e.g., database “UserN_DB” for User N in FIG. 3) that replicated information from the Project Database that is relevant to a particular user, such as User N. The UserN_DB may also contain additional user-specific information that is relevant to User N. In some implementations, the user specific database UserN_DB may also be part of the computer-readable storage devices 106 in the computing system 102 of FIG. 1, although in general, the user specific database UserN_DB may be stored in any suitable location.

In some implementations, the system may also include a local database (e.g., the database “Local_DB” in FIG. 3) for the User N. For example, when User N logs into a front-end client application (e.g., a web-based interface or an interface in a downloadable application), the client application may replicate the user-specific database (UserN_DB) into the local front-end client database (Local_DB). In some implementations, a local database (e.g., Local_DB) may enable a user (e.g., User N) to access the user's data related to different moviemaking projects in an off-line manner without necessarily being required to communicate online with a remote server (e.g., the computing system 102 in FIG. 1) that hosts the Project Database and other data stores associated with the user's moviemaking projects. In some implementations, if a user uploads a media clip, then the user's local database (e.g., Local_DB in FIG. 3) can directly communicate with a remote server (e.g., Storage Server in FIG. 3) to upload the user's media clip to a shared database (e.g., in a cloud-based storage).

In some implementations, changes to the user's local database (e.g., Local_DB in FIG. 3) automatically replicate into the remote user-specific database (e.g., UserN_DB) once an internet connection is available. Conversely, changes to the remote user-specific database UserN_DB (e.g., as a result of relevant media clips and/or versions of the movie contributed by other users) may automatically replicate into the user's local database Local_DB.

For example, if User N makes an update to Project_11 (e.g. adds a new media clip, adds a comment, votes, or performs any other social interaction), then the system may first update the user's local database Local_DB. The system may then automatically replicate the changes into the remote user-specific database UserN_DB, which in turn updates data associated with Project_11 stored in the Project Database. In some implementations, any other users who are also collaborating on Project_11 will automatically have their user-specific database (e.g., UserX_DB for another User X) updated based on these changes, which in turn replicates into the local database Local_DB for the other user (e.g., User X).

Duplication of data on Project Database and UserN_DB

In some implementations, projects on which a user (e.g., User N) is collaborating may be duplicated on both the Project Database as well as the user-specific database (e.g., UserN_DB). Duplicating information in both databases may, in some implementations, provide advantages, for example:

Security—duplicating a user's projects into a user-specific database (e.g., UserN_DB) may help ensure that the front-end client for the user is only able to access project information that is relevant to the particular user, without necessarily being required to grant the user's front-end client with access to the entire Project Database.

Processing Efficiency—maintaining project data in a secure Project Database may enable control software to monitor a single database for changes to projects, without necessarily being required to monitor potentially numerous separate user-specific databases.

Collaboration—The duplication of project information into a central Project Database may help enable a secure central reference point for all collaborating users to securely access the shared information on a project.

User Database

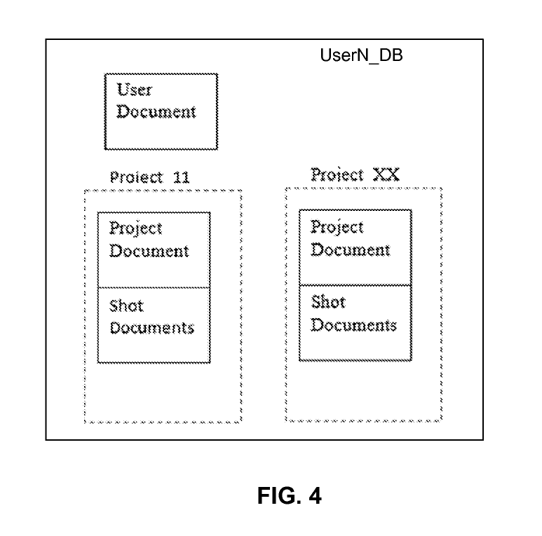

FIG. 4 is a block diagram illustrating an example of a user-specific database (e.g., the UserN_DB in FIG. 3). In this example, the user database UserN_DB contains a memory portion (e.g., the “User Document” in FIG. 4) that stores user-specific information such as a user profile, project identifiers, historical log-in and log-out data, status information, etc.

The user-specific database UserN_DB may also store information related to specific projects. For example, in some implementations, the user-specific database UserN_DB may store project documents and shot documents associated with each project. The project documents (e.g., the “Project Document” in FIG. 4) may store information related to the project that can only be edited by administrative users (e.g., a user who sets up the project, such as a director defining the initial timeline). As an example, the Project Document may contain various types of information related to the project, such as:

Administrative User ID

Invited User IDs

Reference to originating template document

Type of Project

Name and Start Date of Project

Algorithm(s) to generate a crowd-view movie

Soundtrack

Text

Scenes

List of shots in the timeline

In addition to the Project Document, the UserN_DB may also store shot documents (e.g., in the “Shot Documents” in FIG. 4) associated with each project. The Shot Documents may store, for example, descriptions of each shot position in the timeline. In some implementations, the Shot Documents may be editable by any user collaborating on the project (e.g., invited users in addition to the administrative user). As a specific example, if 10 different users upload 10 different media clips for the first shot in a timeline, then there may be 10 different shot documents stored for the first shot. In some implementations, a Shot Document may contain various types of information such as:

userID—person who used the media clip for this shot.

creatorID—person who originally added the media clip to this shot.

projectID—the project associated with the media clip for this shot.

shotID—the position of the shot in the timeline.

public/private indicator for the shot.

Name of the shot.

Status of the shot.

Text associated with the shot.

Editing effects of the shot.

mediaID—an identifier of the media clip for the shot

Metadata—metadata associated with the media clip in this shot.

In some implementations, the Project Document and the Shot Documents may also be stored in the Project Database, replicating the data stored in the user-specific database UserN_DB.

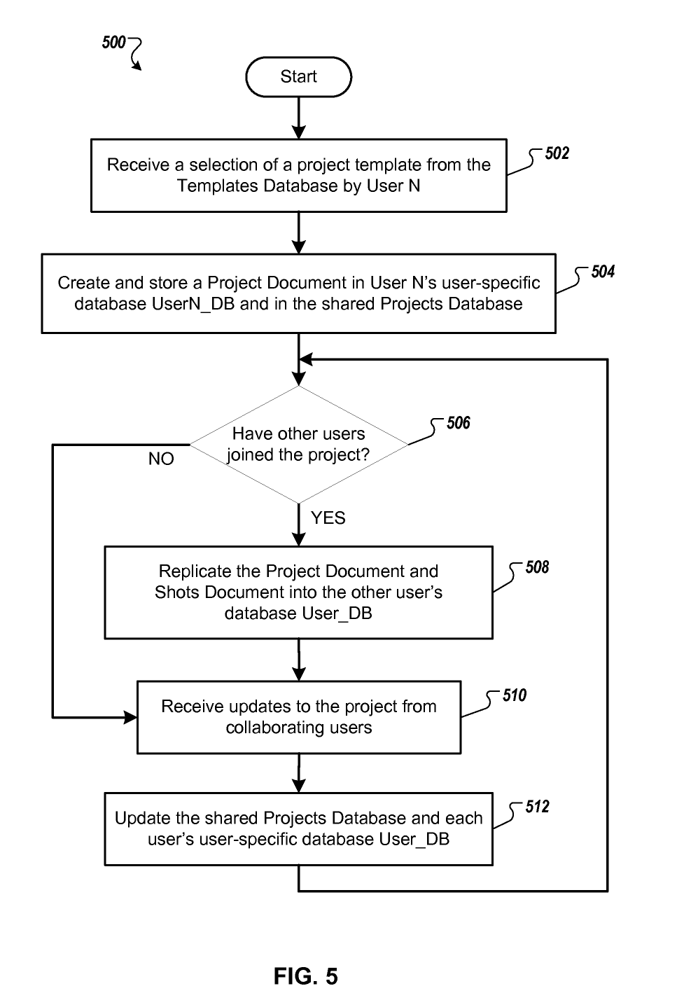

Referring now to FIG. 5, a flow chart is illustrated of an example of collaborative movie making. The example process 500 may be performed by a computing system (e.g., computing system 102 in FIG. 1, or the combination of the Project Database, Control Software, Templates Database, Storage Server, and Video Transcoding module in FIG. 3) that enables crowd-sourced collaborative movie-making.

In the example process 500, a user (e.g., a director or other administrative user) may initially start a project and may invite other users to join the project. To start a new project, the administrative user (e.g., User N) selects, in operation 502, a template from a templates database (e.g., the Templates Database in FIG. 3) as the starting point. For example, when the administrative user starts a project, the system may create a starting Project Document based on the selected template document. The starting Project Document may include a timeline with a fixed number of shots in sequence.

The system may then create, in operation 504, a new project based on the starting Project Document and may add the new Project Document to the administrative user's user-specific database (e.g., the UserN_DB in FIG. 3) as well as to a projects database (e.g., the Projects Database in FIG. 3). In some implementations, a Shot Document may also be stored in the administrative user's database UserN_DB and in the shared Projects Database. The administrative user may then make edits to the Project Document and/or the Shot Document and invite other users to join the project.

The system may then detect, in operation 506, that another user has joined the project. This may be a result of, for example, the new user accepting an invitation from the administrative User N, or may be a result of any other suitable technique of adding new users to the project.

The system may then replicate, in operation 508, the Project Document and Shot Documents to the new user's user specific database (e.g., User_DB). In some implementations, the new invited user is not granted access to edit the Project Document. Instead, in such scenarios, any changes that the administrative user makes to the Project Document (e.g. changing the timeline) may automatically update the replicated Project Document that is stored in the user-specific databases of the invited users. In some implementations, the invited users may be granted access to upload new media clips to the project and, in doing so, may change the Shot Document that is stored in all of the user-specific databases and in the shared Projects Database.

Changes to the project may be received by the system, in operation 510, from the administrative user and/or from invited users. Based on the received changes to the project, the system may update, in operation 512, the shared Projects Database as well as each user's user-specific database, User_DB.

The system may then continue monitoring for new users to the project and/or new updates to the project from existing collaborating users.

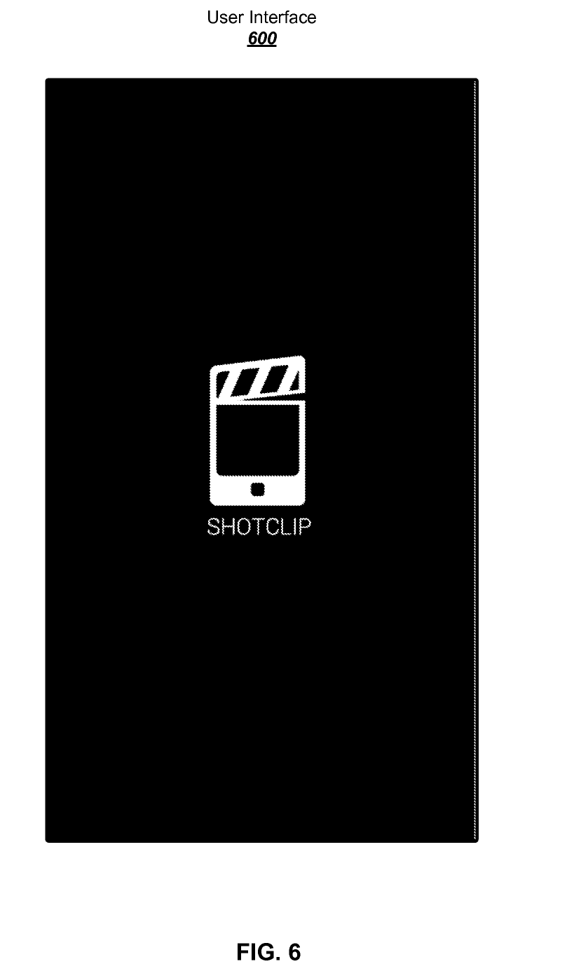

FIG. 6 illustrates an example screen 600 that may be displayed while an application that enables crowd-based collaborative movie making is launching or otherwise performing one or more content loading processes.

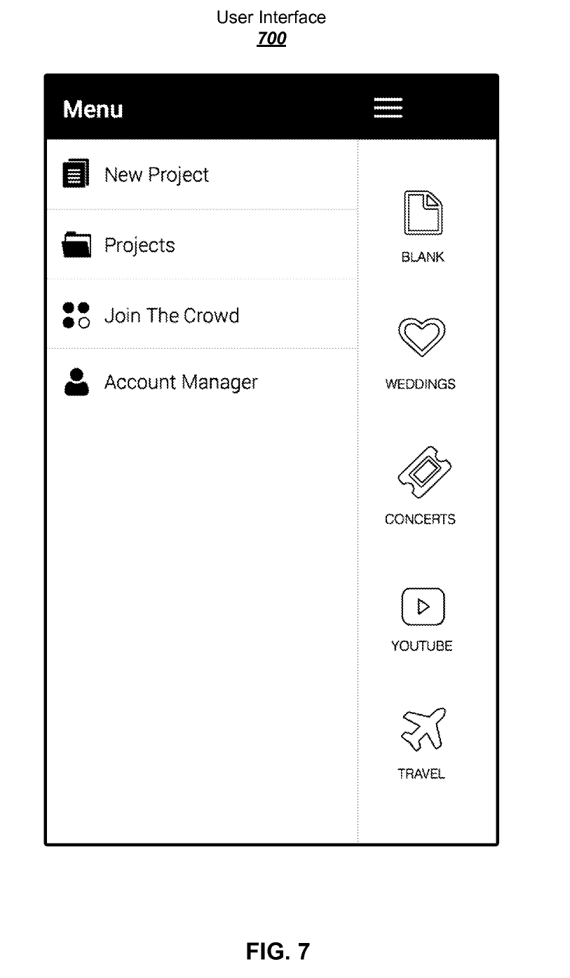

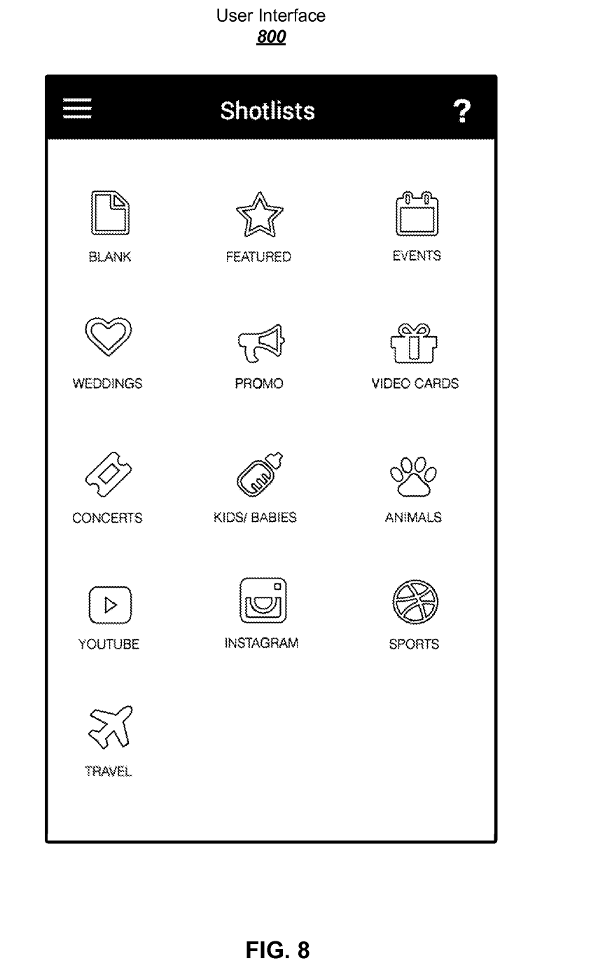

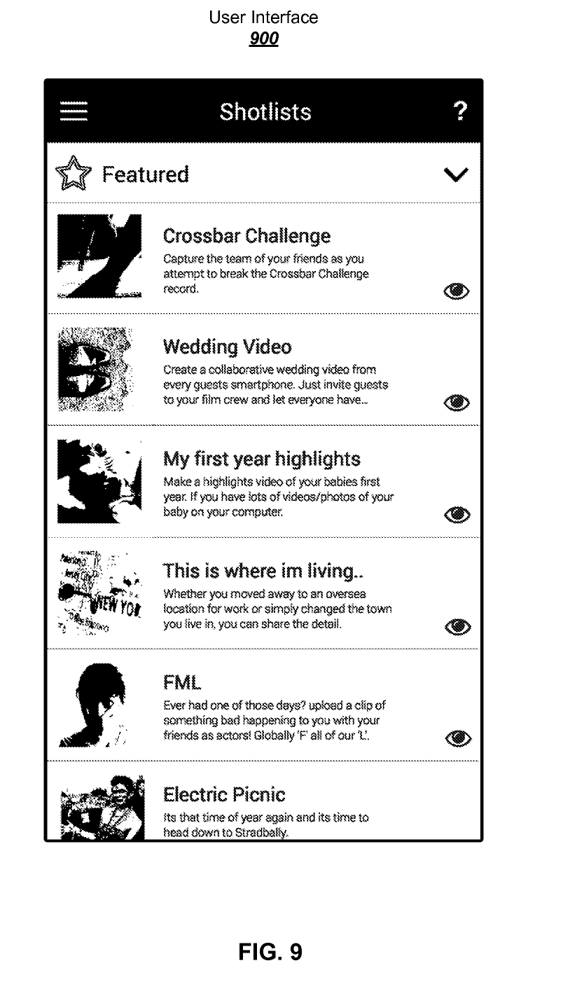

FIGS. 7-8 illustrates example interfaces 700-800 providing a menu that enables a user to select among various categories of movies to start a new movie making project or to join an existing project. In this example, selecting the “Featured” category results in the user interface illustrated in FIG. 9.

FIG. 9 illustrates an example interface 900 that enables a user to edit or create a project in the “Featured” movies category, including a movie about “This is where I'm living,” and a movie about the Electric Picnic Festival.

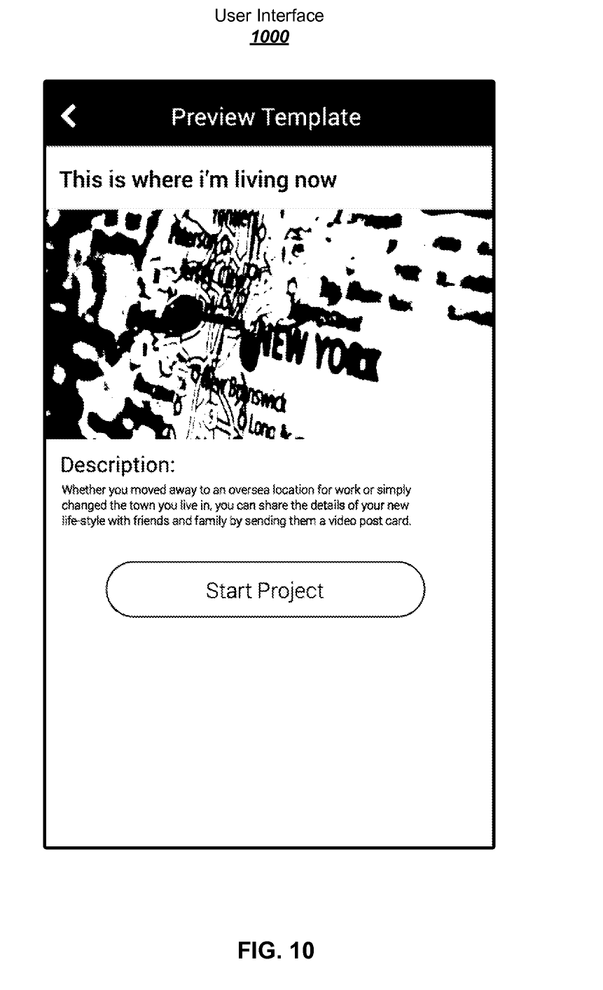

FIG. 10 illustrates an example interface 1000 that enables a user to select a template for a movie and start a new project using the selected template.

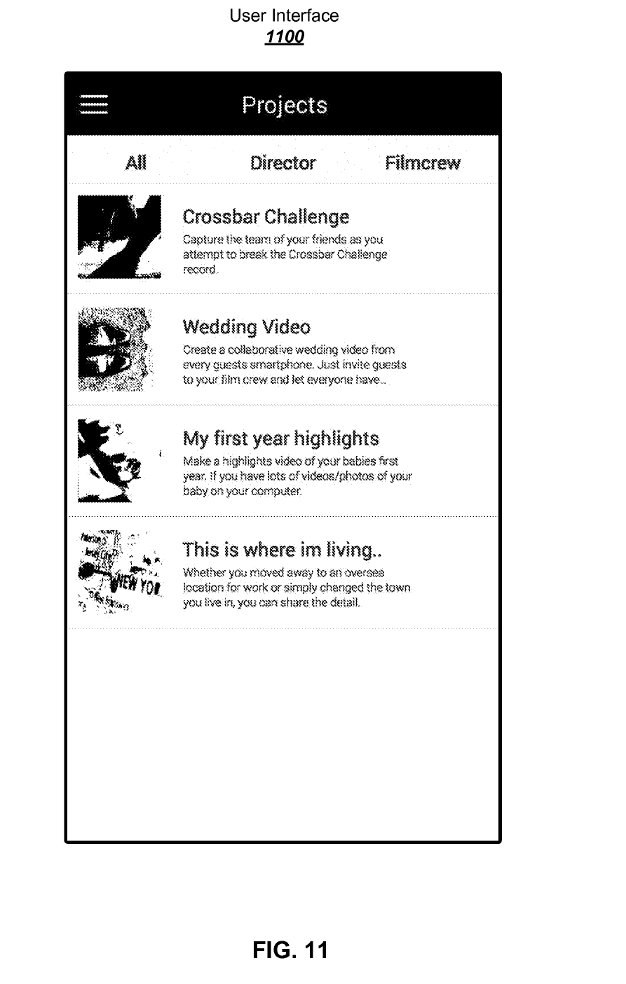

FIG. 11 illustrates an example user interface 1100 that enables a user to select media clips from a library of available media clips for different types of projects. The media clips may have been contributed by one or more different users, or automatically generated by the system.

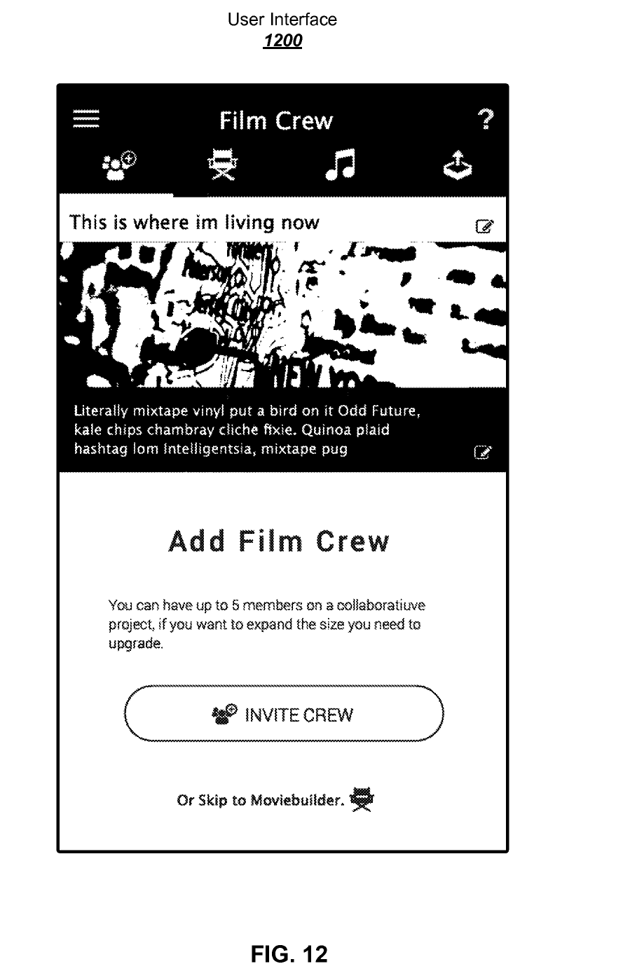

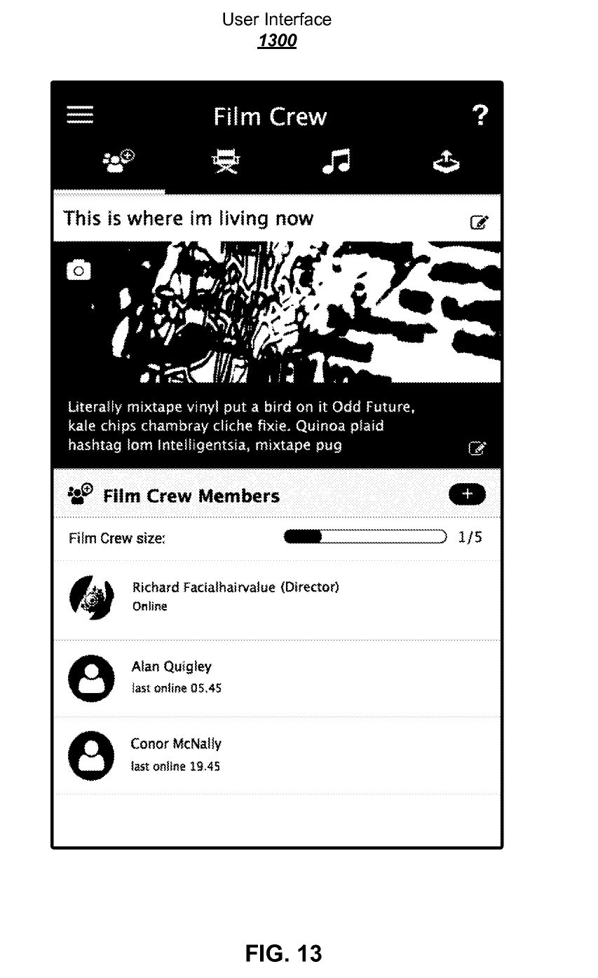

FIGS. 12-13 illustrate example interfaces 1200-1300 that enable a user to invite other users to join a collaborative movie making effort as part of a “film crew.”

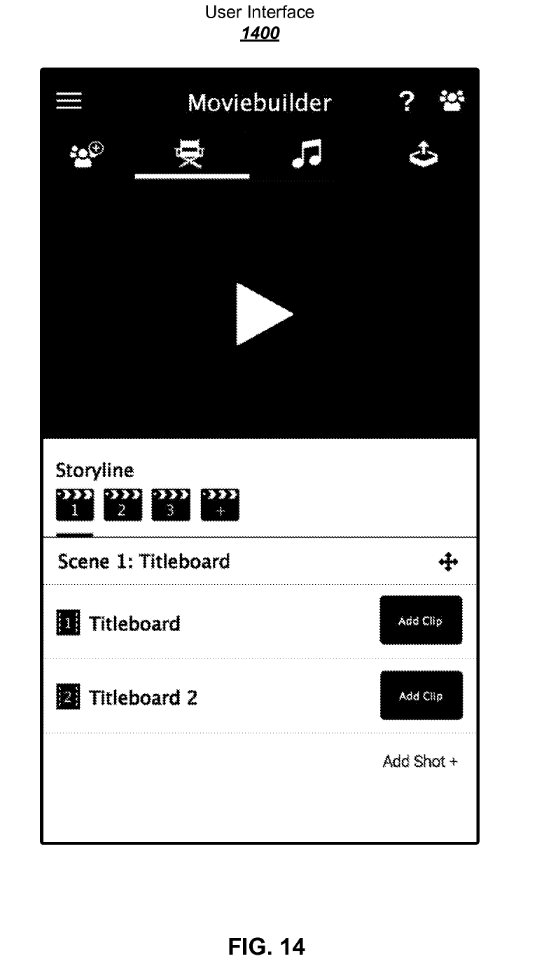

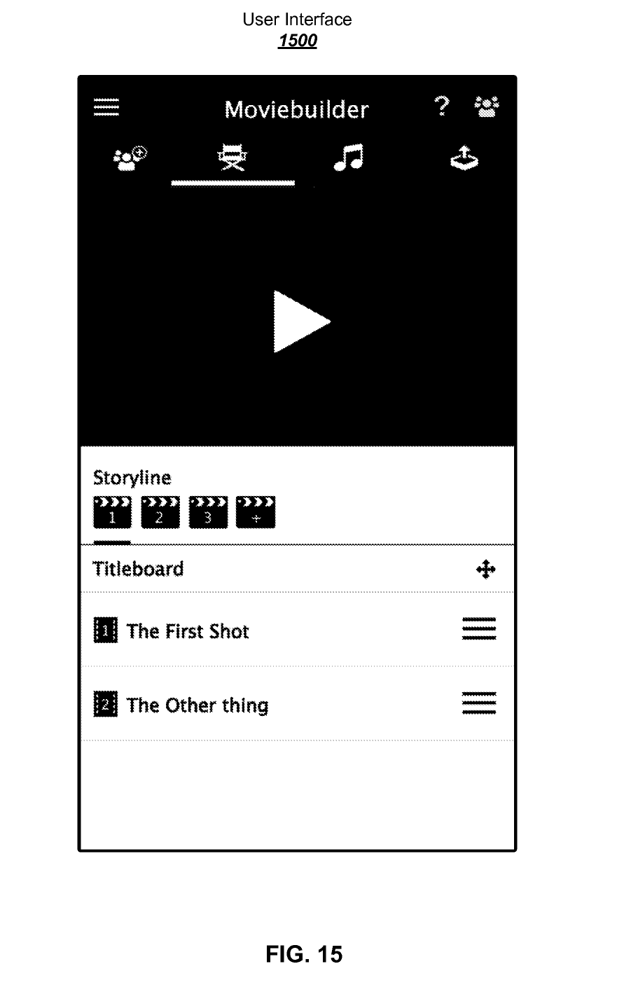

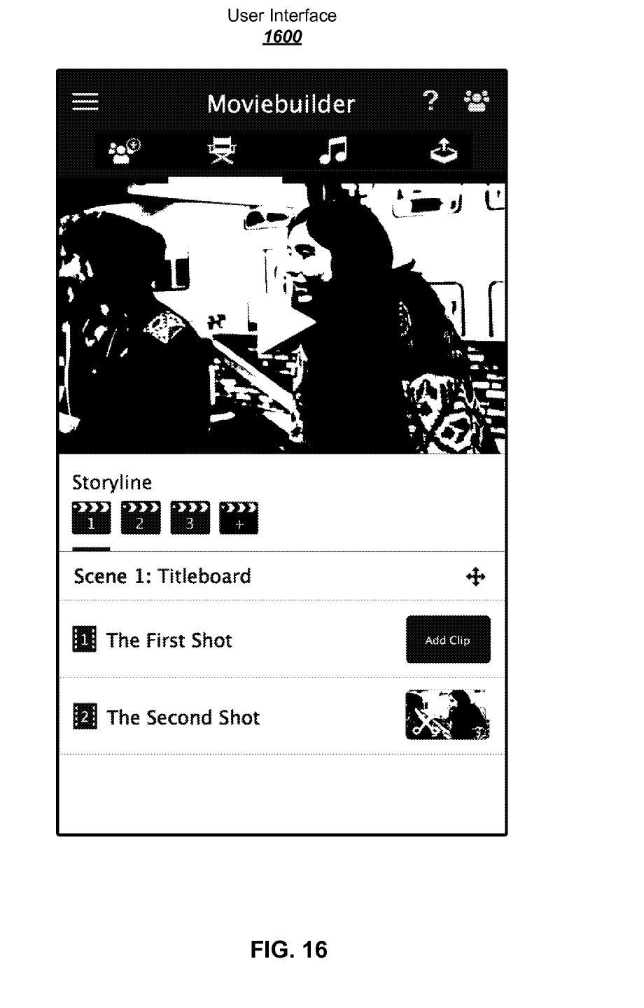

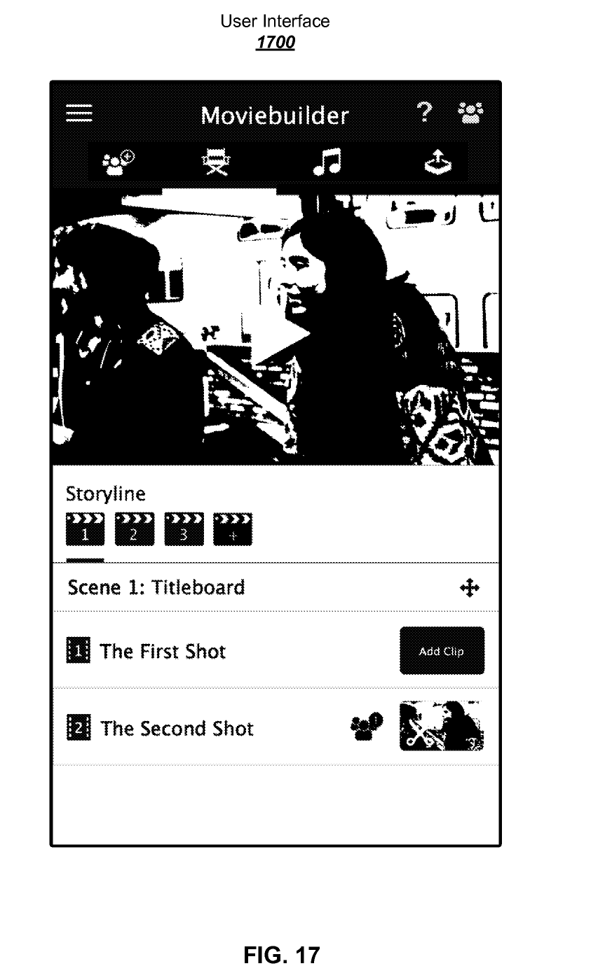

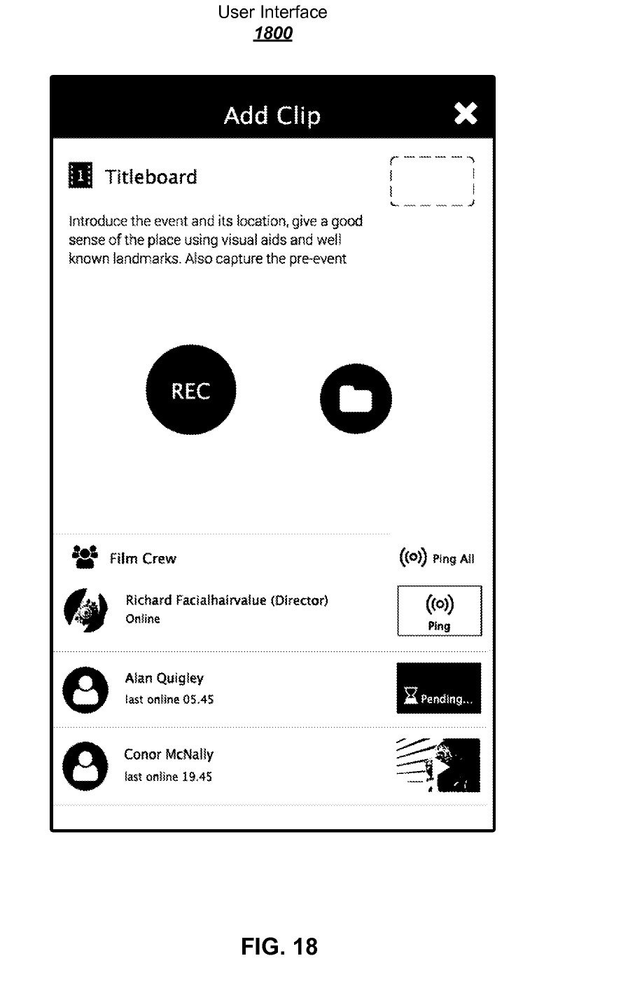

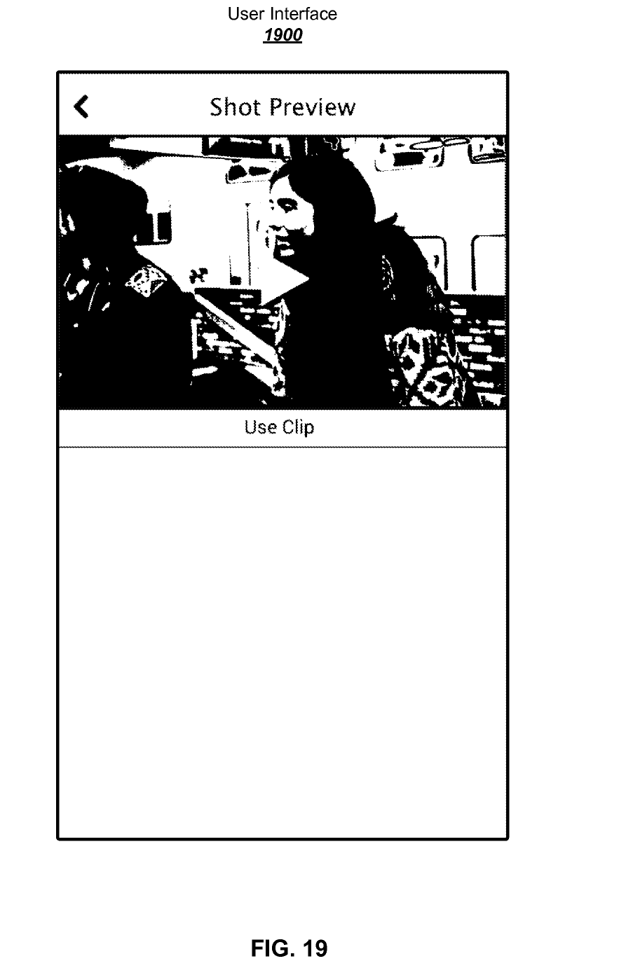

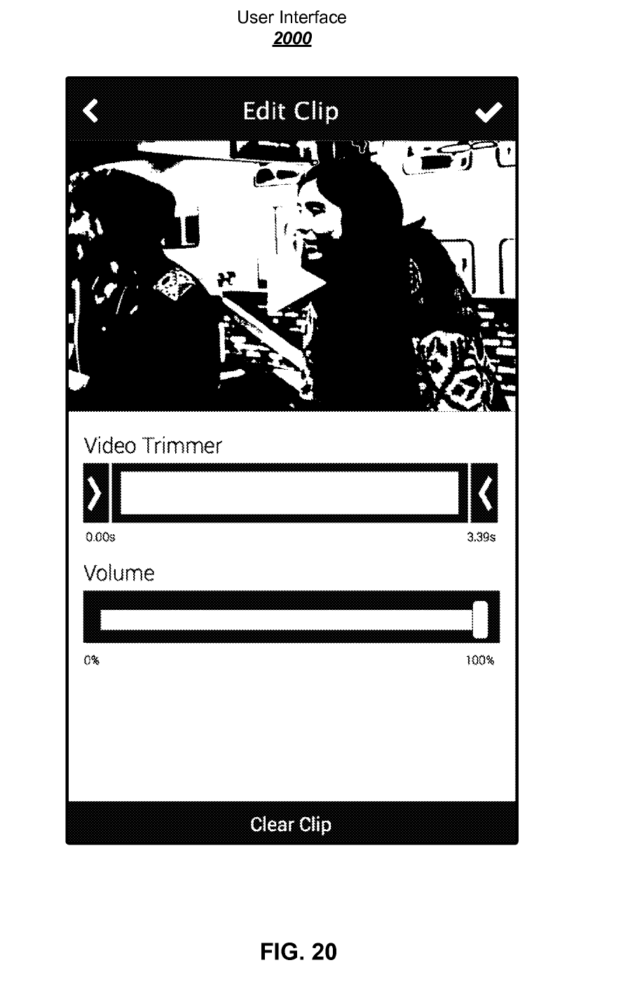

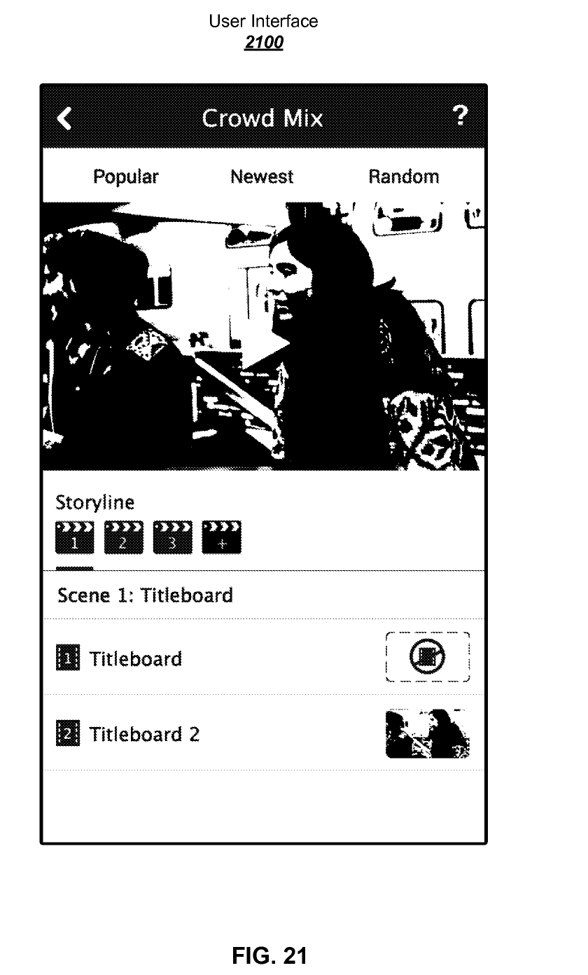

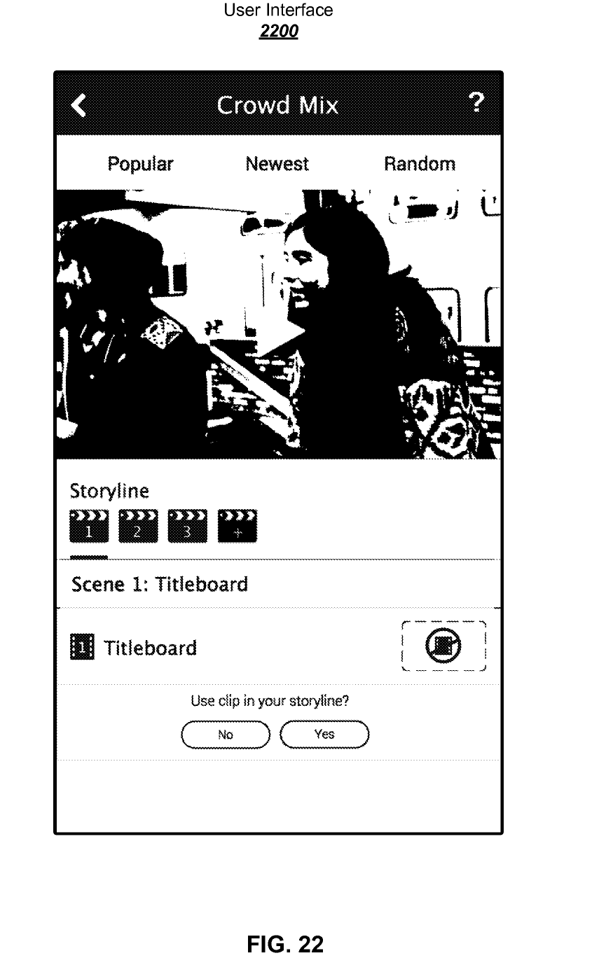

FIGS. 14-22 illustrates example interfaces 1400-2200 that enable the user to create a new movie based on the “This is where I'm living” movie template. FIG. 18, for example, illustrates an interface 1800 that enables the user to contact different members of the “film crew” by triggering provision of a push notification to one or more computing devices associated with film crew members.

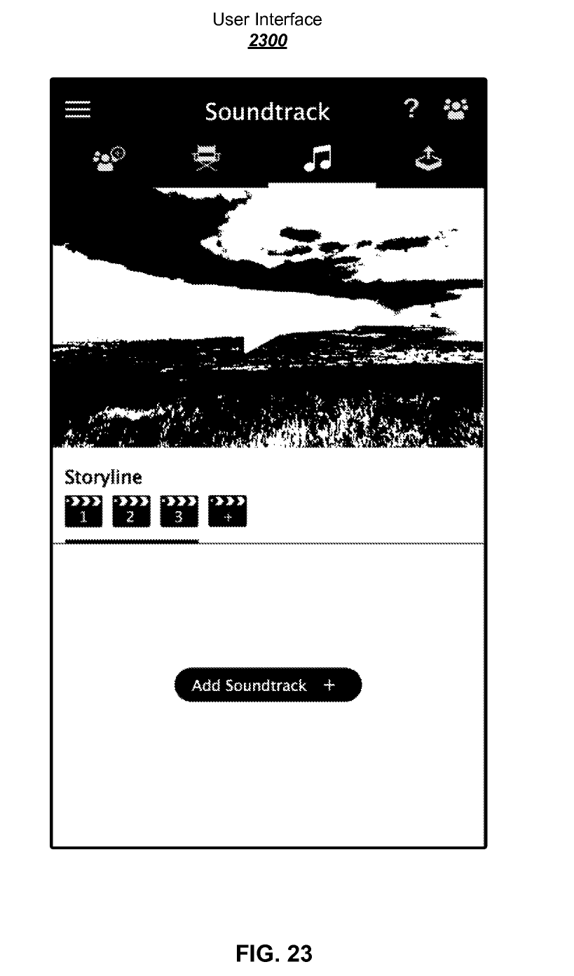

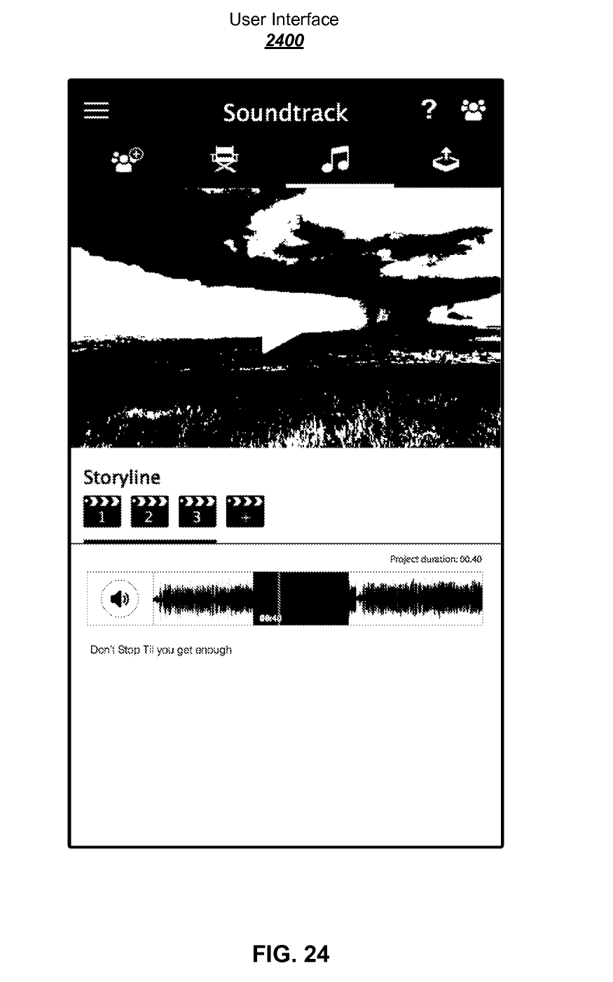

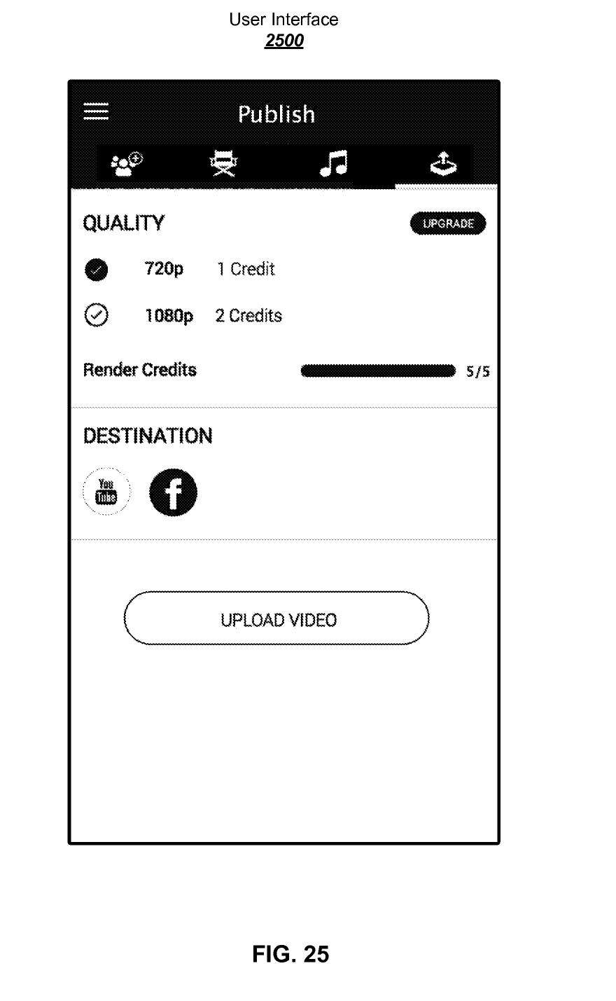

FIGS. 23-25 illustrate example interfaces 2300-2500 that enable a user to select a soundtrack for the movie, and to publish the resulting movie.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

The processes described herein may, for example, be performed within at least one camera, smart phone, television, personal computer, cloud computing device, or a combination thereof, and in association with one or more applications or services. Such applications and services may include video editing suites, community video uploading sites, social networks, and streaming media services. Content produced by way of the processes described herein may be stored for distribution through a community video uploading site, social network, streaming media service, digital vault, media gallery, and the like.

Implementations and all of the functional operations described in this specification may be realized in digital electronic circuitry, or in computer software, firmware, or hardware, including the structures disclosed in this specification and their structural equivalents, or in combinations of one or more of them. Implementations may be provided using one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be provided on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be provided in a computing system that includes a back end component, e.g., as a data server, or that includes a middleware component, e.g., an application server, or that includes a front end component, e.g., a client computer having a graphical user interface or a Web browser through which a user may interact with an implementation, or any appropriate combination of one or more such back end, middleware, or front end components. The components of the system may be interconnected by any appropriate form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be provided in combination in a single implementation. Conversely, various features that are described in the context of a single implementation may also be provided in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

What is claimed is:

1. A computer-implemented method comprising:
determining, by a processor, a timeline of shots for a movie;
for each user in a group of users:
receiving, from a device of the user and for each shot of the timeline, a selection of one or more media clips associated with the shot; and
storing, in the computer memory, the selected one or more media clips associated with the shot in a sequence of media clips selected by the user for the timeline of shots, the sequence of media clips defining a version of the movie created by the user;
determining, by the processor, selection information related to the selection of media clips by the group of users in creating the versions of the movie; and
storing, in the computer memory, the selection information.

2. The method of claim 1, further comprising:
for a particular shot in the timeline:
accessing, by the processor, a set of candidate media clips that is stored in the computer memory; and
associating the set of candidate media clips with the particular shot in the timeline,
wherein the selected one or more media clips is selected from among the set of candidate media clips associated with the particular shot in the timeline.

3. The method of claim 1, further comprising:
for a particular shot in the timeline:
transmitting, to a device of at least one user in the group of users, an indication to record a media clip for the particular shot in the timeline;
receiving, from the device of the at least one user, a recorded media clip for the particular shot in the timeline; and
setting, by the processor and for the at least one user, the recorded media clip as the selection of one or more media clips associated with the particular shot in the timeline.

4. The method of claim 1, wherein determining the timeline of shots for the movie comprises receiving an ordered sequence of shots.

5. The method of claim 1, wherein each shot in the timeline of shots for the movie includes a description of a scene or portion of a story associated with the movie.

6. The method of claim 1, wherein the selected one or more media clips for the shot includes at least one of a video file, an image file, or an audio file.

7. The method of claim 2, further comprising:
determining metadata associated with the set of candidate media clips; and
storing the metadata.

8. The method of claim 5, wherein the metadata comprises information regarding a characteristic of audio, video, image, or text that appears in a candidate media clip.

9. The method of claim 5, wherein the metadata comprises information regarding a source of a candidate media clip.

10. The method of claim 7, wherein the information regarding a user is related to at least one of a location of the user, a time at which the user uploaded the candidate media clip, one or more social network connections of the user, or demographic information associated with the user.

11. The method of claim 2, further comprising downloading, from a predetermined database, at least one candidate media clip of the set of candidate media clips.

12. The method of claim 2, further comprising receiving, from a user, at least one candidate media clip of the set of candidate media clips.

13. The method of claim 2, wherein associating a set of candidate media clips with each shot of the timeline comprises:
determining, for each shot of the timeline, an ordering for the set of candidate media clips associated with the shot based on analyzing metadata associated with the set of candidate media clips or based on the selection information related to the selection of media clips by the group of users in creating the versions of the movie.

14. The method of claim 1, wherein determining selection information related to the selection of media clips by the group of users in creating the versions of the movie comprises:
determining a frequency or timing with which a particular media clip is selected by the group of users in creating the versions of the movie.

15. The method of claim 1, wherein determining selection information related to the selection of media clips by the group of users in creating the versions of the movie comprises:
determining a frequency or timing with which two or more particular media clips are selected in the same sequence of media clips by the group of users in creating the versions of the movie.

16. The method of claim 1, wherein determining selection information related to the selection of media clips by the group of users in creating the versions of the movie comprises:
determining a rating that has been assigned to the media clips by the group of users in creating the versions of the movie.

17. The method of claim 1, wherein determining selection information related to the selection of media clips by the group of users in creating the versions of the movie comprises:
determining demographic information of users who have selected a particular media clip in creating the versions of the movie.

18. A computer-implemented method comprising:
receiving, from a viewer, a request to view a version of a movie according to one or more preferences specified by the viewer;
accessing one or more stored sequences of media clips created by a group of users, each sequence of media clips defining a version of the movie created by a user in the group of users;
generating the requested version of the movie according to the one or more preferences specified by the viewer based on selecting, for each shot in a timeline of shots for the movie, one or more media clips that are used for the shot in at least one of the one or more stored sequences of media clips created by a group of users; and
displaying, for the viewer, the requested version of the movie.

19. The method of claim 16, wherein the one or more preferences specified by the viewer comprise a preference to view the requested version of the movie based on a frequency or timing with which media clips were selected by the group of users in creating the versions of the movie.

20. The method of claim 16, wherein the one or more preferences specified by the viewer comprise a preference to view the requested version of the movie based on versions of the movie created by users in the group of users who have a particular demographic profile.

21. The method of claim 16, wherein the one or more preferences specified by the viewer comprise a preference to view the requested version of the movie based on a characteristic of audio, video, or text that appears in one or more media clips in the versions of the movie created by the group of users.

22. The method of claim 16, wherein selecting, for each shot in a timeline of shots for the movie, one or more media clips that are used for the shot in at least one of the one or more stored sequences of media clips created by a group of users comprises:
selecting the one or more media clips based on at least one of:
selection information related to the selection of the one or more media clips by the group of users in creating the versions of the movie, or
metadata associated with the one or more media clips.

23. The method of claim 20, wherein the selection information for the one or more media clips comprises information regarding a frequency or timing with which the one or more media clips were selected by the group of users in creating the versions of the movie.

24. The method of claim 20, wherein the selection decision information for the one or more media clips comprises a frequency or timing with which the one or more media clips were selected with one or more particular media clips in the same sequence of media clips by the group of users in creating the versions of the movie.

25. The method of claim 20, wherein the selection information for the one or more media clips comprises a rating that has been assigned to the one or more media clips by the group of users in creating the versions of the movie.

26. The method of claim 20, wherein the selection information for the one or more media clips comprises demographic information associated with users who selected the one or more media clips to appear in versions of the movie created by the users.

27. The method of claim 24, wherein the demographic information associated with users who selected the one or more media clips to appear in versions of the movie created by the users comprises information regarding a relationship between the users who selected the one or more media clips and the viewer.

28. The method of claim 20, wherein the metadata associated with the one or more media clips comprises information regarding a characteristic of audio, video, or text that appears in the one or more media clips, and wherein the characteristic of video is related to background information or foreground information of the video.

29. The method of claim 20, wherein the metadata associated with the one or more media clips comprises information regarding a source of the one or more media clips.

30. The method of claim 20, wherein the metadata associated with the one or more media clips comprises information regarding at least one of a geographic location or a time at which the one or more media clips were uploaded.

31. The method of claim 16, further comprising:
receiving feedback from the viewer regarding the displayed requested version of the movie; and
updating, based on the received feedback from the viewer regarding the displayed requested version of the movie, an algorithm that is used to generate the requested version of the movie according to one or more preferences specified by the viewer.

32. The method of claim 16, further comprising:
receiving, from a second viewer, a request to view a second version of a movie according to one or more preferences specified by the second viewer;
accessing the one or more stored sequences of media clips created by the group of users;
generating the requested second version of the movie according to the one or more preferences specified by the second viewer based on selecting, for each shot in the timeline of shots for the movie, one or more media clips that are used for the shot in at least one of the one or more stored sequences of media clips created by the group of users; and
displaying, for the second viewer, the requested second version of the movie.

33. A system comprising:
one or more computers; and
a computer-readable medium coupled to the one or more computers having instructions stored thereon which, when executed by the one or more computers, cause the one or more computers to perform operations comprising:
determining a timeline of shots for a movie;
for each user in a group of users:
receiving, from the user and for each shot of the timeline, a selection of one or more media clips associated with the shot; and
storing the selected one or more media clips associated with the shot in a sequence of media clips selected by the user for the timeline of shots, the sequence of media clips defining a version of the movie created by the user;
determining selection information related to the selection of media clips by the group of users in creating the versions of the movie; and
storing the selection information.

34. A computer storage medium encoded with a computer program, the computer program comprising instructions that when executed by one or more processors cause the one or more processors to perform operations comprising:
determining a timeline of shots for a movie;
for each user in a group of users:
receiving, from the user and for each shot of the timeline, a selection of one or more media clips associated with the shot; and
storing the selected one or more media clips associated with the shot in a sequence of media clips selected by the user for the timeline of shots, the sequence of media clips defining a version of the movie created by the user;
determining selection information related to the selection of media clips by the group of users in creating the versions of the movie; and
storing the selection information.

35. A system comprising:
one or more computers; and
a computer-readable medium coupled to the one or more computers having instructions stored thereon which, when executed by the one or more computers, cause the one or more computers to perform operations comprising:
receiving, from a viewer, a request to view a version of a movie according to one or more preferences specified by the viewer;
accessing one or more stored sequences of media clips created by a group of users, each sequence of media clips defining a version of the movie created by a user in the group of users;
generating the requested version of the movie according to the one or more preferences specified by the viewer based on selecting, for each shot in a timeline of shots for the movie, one or more media clips that are used for the shot in at least one of the one or more stored sequences of media clips created by a group of users; and
displaying, for the viewer, the requested version of the movie.

36. A computer storage medium encoded with a computer program, the computer program comprising instructions that when executed by one or more processors cause the one or more processors to perform operations comprising:
receiving, from a viewer, a request to view a version of a movie according to one or more preferences specified by the viewer;
accessing one or more stored sequences of media clips created by a group of users, each sequence of media clips defining a version of the movie created by a user in the group of users;
generating the requested version of the movie according to the one or more preferences specified by the viewer based on selecting, for each shot in a timeline of shots for the movie, one or more media clips that are used for the shot in at least one of the one or more stored sequences of media clips created by a group of users; and
displaying, for the viewer, the requested version of the movie.
